(19) United States
(12) Patent Application Publication
(10) Pub. No.: US 2014/0168507 A1
(43) Pub. Date: Jun. 19, 2014

(54) Camera Module With Enhanced Heat Dissipation

(71) Applicant: Integrated Micro-Electronics, Inc., Laguna (PH)

(72) Inventor: David Renaud, Sofia District (BG)

(21) Appl. No.: 14/109,918

(22) Filed: Dec. 17, 2013

Related U.S. Application Data
(60) Provisional application No. 61/737,836, filed on Dec. 17, 2012.

(51) Int. Cl. H04N 5/225

(52) U.S. Cl. CPC H04N 5/2253
USPC 348/373

(57) ABSTRACT

The present invention describes embodiments of a camera module (100, 100a, 100b) with enhanced heat dissipation. Heat generated from an image sensor (40) is conducted through a circuit substrate (150), a lens holder (130) disposed on a front face of the circuit substrate (150), an overmolded cover (174, 176, 178) and a cable connection (190). Further heat is conducted away through support members (136) of the camera module. In addition, heat is convected from ribs (134) formed on an external surface of the lens holder (130).

### RELATED APPLICATION

The present application claims priority from U.S. provisional application No. 61/737,836 filed on 17 Dec. 2012 and the disclosure of which is incorporated herein.

### FIELD OF INVENTION

The present invention relates to a camera module designed to enhance heat dissipation from an imaging sensor, and an attendant method of improving manufacturability and product reliability.

### BACKGROUND

A camera module generally comprises an image sensor integrated circuit mounted on a printed circuit board (PCB) substrate. As in any other electronic device, the PCB includes other circuits, for example, for power supply regulation, input-output noise reduction, noise immunity, circuit protection and image processing. With the trend to capture images at higher pixel density and frame rates, the amount of image capturing and processing has increased; this leads to higher amounts of heat generated in the image sensors and circuits mounted on the PCB. Most cameras and electronic gadgets, have an upper temperature limit of about 50-60 degree C.; near the upper temperature limit, noises in the captured images start to appear. Heat accumulation in a camera becomes a problem and heat dissipation is made worse by reducing the size of the camera housing and putting cameras to work in an out-door environment or in motor vehicles where summer temperatures can exceed the upper temperature limit. In the other extreme, putting cameras to work in an out-door environment or in vehicles subjects cameras to cold start in cold temperatures.

A camera module is also comprised of many parts. Assembly of some of these parts requires manual adjustments, thus making fully automated assembly difficult. In addition, screw joints commonly employed during assembly contribute to a major problem of particle contamination and reliability issues.

It can thus be seen that there exists a need to solve heat dissipation problem in cameras and another way of assembling camera components for ease of manufacture and improved reliability.

### SUMMARY

The following presents a simplified summary to provide a basic understanding of the present invention. This summary is not an extensive overview of the invention, and is not intended to identify key features of the invention. Rather, it is to present some of the inventive concepts of this invention in a generalised form as a prelude to the detailed description that is to follow.

The present invention seeks to provide a camera or imaging module that has enhanced heat dissipation features and method. A camera using the camera or imaging module of the present invention has a rugged body formed by low pressure plastic overmolding; the camera module thus has superior resistance to shock and vibration compared to conventionally assembled cameras, making them very suitable for use in automobiles. The image sensor and circuit substrate(s) are all fully sealed by the overmolding material. Advantageously, corrosion linked to vapour condensation on the. electronic circuitry is completely suppressed; similarly, ingress protection is provided at the highest level, exceeding that required for use in automotive vehicles. The sensor chamber has a reduced volume and advantageously has shorter time of blur when operated in cold start.

In one embodiment, the present invention provides an imaging device. The imaging device comprises a lens module, an image sensor and a lens holder. The image sensor is mounted in line with said lens module, with said image sensor being mounted on a circuit substrate. The lens holder supports said lens module and a rear end of said lens holder has an annular contact area. A heat transfer layer on said circuit substrate describes or segments of a heat transfer layer describe an annular area around said image sensor matching the shape of said annular contact area at said rear end of said lens holder, and heat generated at said image sensor is conducted to said lens holder through said heat transfer layer/segments of said heat transfer layer and said rear end of said lens holder.

In one embodiment, the lens holder is made of a thermal conductive polymer, aluminium, aluminium alloy or a metal. In another embodiment, the imaging device comprises a rear housing, which is also made of a plastic, aluminium, aluminium alloy or a metal. Covers over the electronic circuit substrate(s) are formed by low pressure overmolding of a thermally conductive thermoplastic.

In another embodiment, the present invention provides a method of enhancing heat dissipation in a camera module. The method comprises mounting a lens holder to support a lens module and conducting heat generated at an image sensor mounted on a circuit substrate to a rear end of said lens holder through a heat transfer layer formed on said circuit substrate.

The method also comprises relocating circuits not directly related to image capturing to secondary circuit substrates, which are spatially separated from the sensor circuit substrate. In addition, it also comprises forming covers for the circuit substrate and other secondary circuit substrate so that there is a continuous thermal conduction path for heat dissipation away from the circuit substrate(s).

### BRIEF DESCRIPTION OF THE DRAWINGS

This invention will be described by way of non-limiting embodiments of the present invention, with reference to the accompanying drawings, in which:

FIG. 1A illustrates a conventional imaging module, whilst FIG. 1B illustrates an inside view of the conventional imaging module;

FIG. 2A illustrates a cross-section view of a camera module according to an embodiment of the present invention; FIG. 2B illustrates directions of heat flux dissipating from the image sensor; FIG. 2C illustrates a lens holder with external ribs; and FIG. 2D shows the camera module complete with an overmolded rear cover, with the rear cover including a cable strain relief molding;

FIG. 3A illustrates a camera module having a rear circuit substrate according to another embodiment of the present invention; FIG. 3B illustrates the camera module shown in FIG. 3A with a lower rear housing and a cable connector; and FIG. 3C illustrates the camera complete with an overmolded top cover; and

FIG. 4A illustrates a camera module having a front end circuit substrate according to another embodiment of the present invention; FIG. 4B illustrates the camera module complete with an overmolded top and rear cover, with the rear cover including a cable strain relief molding.

### DETAILED DESCRIPTION

One or more specific and alternative embodiments of the present invention will now be described with reference to the attached drawings. It shall be apparent to one skilled in the art, however, that this invention may be practised without such specific details. Some of the details may not be described at length so as not to obscure the invention. For ease of reference, common reference numerals or series of numerals will be used throughout the figures when referring to the same or similar features common to the figures.

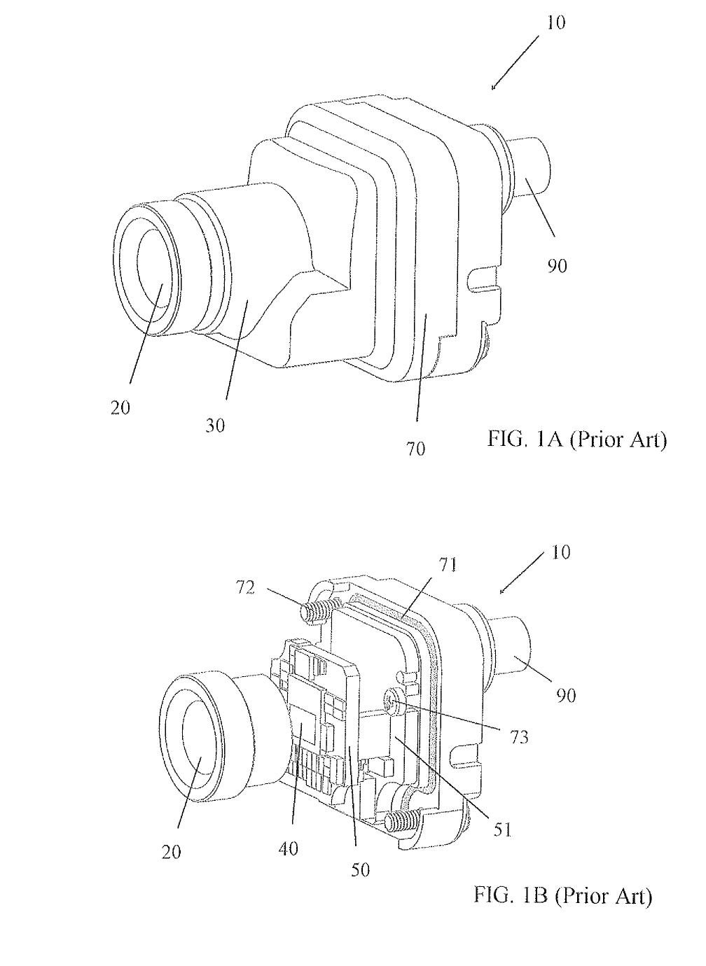

FIG. 1A shows an external view of a conventional imaging module 10 for use in an automotive vehicle or in a factory to provide machine vision, whilst FIG. 1B illustrates an inside view of the imaging module 10. As shown in FIGS. 1A and 1B, the imaging module 10 includes a lens assembly 20, an image sensor 40 mounted on a printed circuit board (PCB) substrate 50, a body 70 including a lens holder 30 and a cable connection 90. In FIG. 1B, a front part of the body and the lens holder are not shown for a clearer view of the interior of the imaging module 10. There are several weaknesses in the construction of this imaging module 10. Firstly, as seen in FIG. 1A, the interior space or sensor chamber around the image sensor 40 is fully enclosed or sealed and the still air around the image sensor 40 acts like a thermal insulation layer. In addition, there is no effective thermal path between the image sensor 40 and the external ambient air. Heat generated by the image sensor 40 and electronic components on the PCB can only be conducted away from the sensor chamber through the body 70, ie. without any heat convection due to the sensor chamber being fully sealed from the exterior. With air being a poor heat conductor, heat accumulates in the imaging module 10, and the image quality and overall reliability of the imaging module become adversely affected.

Secondly, to provide ingress protection against water and dust (for example, IP 44 splash proof), seals or gaskets 71 are employed in some interfaces between sub-assemblies of the imaging module 10. These seals or gaskets 71, located in grooves between two mating edges, require manual alignments and thus make complete automation difficult. In addition, the additional parts, additional features at the interfaces and manual processes greatly affect cost, yield and quality.

Thirdly, in automated assembly processes, some of the mating parts are conventionally joined together with screws 72, 73, as seen in FIG. 1B. Self-taping screws generate electrically conductive burrs and they are found to cause unacceptable particle contamination in the sensor chamber or short circuits on the PCB 50 substrate or any other secondary PCB 51.

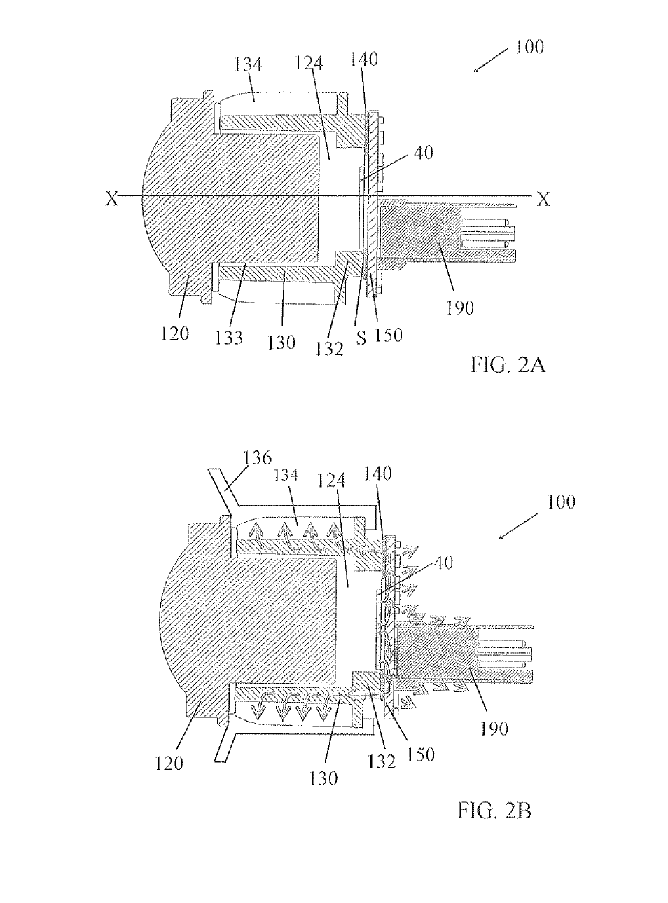

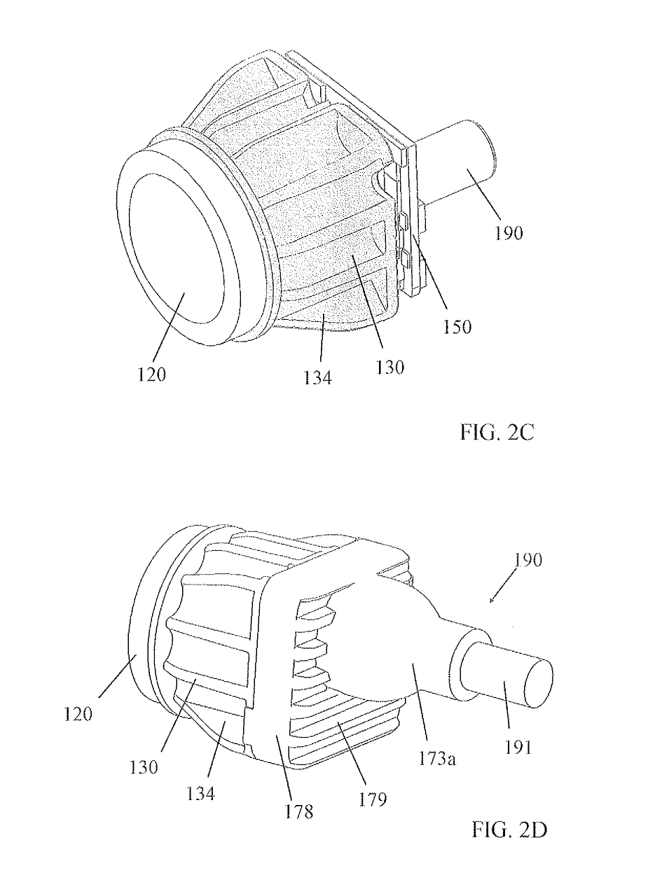

FIG. 2A shows a cross-sectional view of a camera or imaging module 100 according to an embodiment of the present invention. The camera or imaging module 100 includes a lens assembly 120, a lens holder 130, an image sensor 40 mounted on a circuit substrate 150 and a cable connection 190, with centres of the lens assembly 120, lens holder 130 and image sensor 40 arranged along a longitudinal imaging axis XX. In the description, a front position is defined with respect to the lens assembly 120. As shown in FIG. 2A, the lens holder 130 is shaped like a cylindrical cup with an open rear end 132 and a cylindrical bore 133. The wall thickness is substantially about 10-20% of the cylindrical bore 133 whilst the rear open end 132 is dimensioned to fit around an outside perimeter of the image sensor 40 so that the open end has a predetermined annular surface area S for thermal conduction with a front face of the circuit substrate 150. In one embodiment, the perimeter of the image sensor 40 is quadrilateral; in another embodiment, the perimeter of the image sensor 40 is circular. A heat transfer layer 140 made of copper or thermal conductive material on the circuit substrate 150 provides a thermal conduction path at an interface between the image sensor 40 and the lens holder 130. In another embodiment, only segments of the heat transfer layer 140 are arranged in an annular area that matches the shape of the annular area of the rear end 132. In one embodiment, the lens holder 130 is made of a thermal conductive polymer or a metal. A suitable metal for the lens holder 130 is aluminium or an aluminium alloy. In use, the rear end 132 of the lens holder 130 is thermally connected to the heat transfer layer 140 or through the segments of the heat transfer layer 140 by a thermal conductive compound. In one embodiment, the thermal conductive compound is a thermal conductive epoxy. The thermal conductive compound binds the lens holder 130 to the circuit substrate 150, and thus seals the sensor chamber 124 from the exterior environment, so that subsequent processes in the assembly of the imaging module 100 do not have to be performed in a clean room. In turn, heat is conducted away from the lens holder 130 by support elements 136 (as seen in FIG. 2B) of an external housing supporting the lens holder and camera module. To improve heat dissipation from the lens holder, the external surface of the lens holder 130 is formed with a plurality of ribs 134 (as seen in FIGS. 2C and 2D). These ribs 134 increase the external surface area of the lens holder 130 and are provided to increase the amount of convection cooling of the lens holder. The ribs 134 are substantially elongate in the longitudinal imaging axis XX of the camera module 100, as seen in FIG. 2C; in another embodiment (not shown in the figures), each rib 134 is formed in a spiral manner to help generate convective air currents around the lens holder 130. FIG. 2B schematically shows the conduction and convection paths of heat flow from the image sensor 40 through the circuit substrate 150, lens holder 130 and the cable connection 190. In particular, the conductor wires in the cable connection 190 provide an effective heat sink. In later descriptions, a reader will appreciate the enhanced heat dissipation provided by an overmolded cover 174, 176, 178 (as seen in FIGS. 2D and 4B).

As seen in FIG. 2A, an inside part of the lens assembly 120 is arranged close to the image sensor 40 to reduce the volume of the sensor chamber 124. Reduction of the sensor chamber volume 124 is advantageous when the camera module 100 is operated in a cold start, as evident by a greatly reduced time of blur as there is less amount of water vapour in the sensor chamber 124.

FIG. 2D shows camera module 100 with a rear cover 178 and cable strain relief 173a formed by low pressure overmolding of a thermoplastic material. The overmolding material makes contact with all the components on the rear face of circuit substrate 150 and provides a continuous thermal conduction path for heat dissipation from the circuit substrate 150 to the ambient air or the camera support elements 136. The outside face of the rear cover 178 is also formed with cooling fins 179 to further enhance heat dissipation by convection. The overmolding material is also used to bind the different mechanical components and the circuit substrate together into a robust camera assembly. Furthermore, it provides excellent ingress protection needed for the camera to operate in harsh environments. Cable relief 173a is molded over cable 191 which becomes internally attached to the connector 190 and allows gradual flexing of the cable. The cable relief 173a is also designed to take externally applied forces instead of the conductors in the cable.

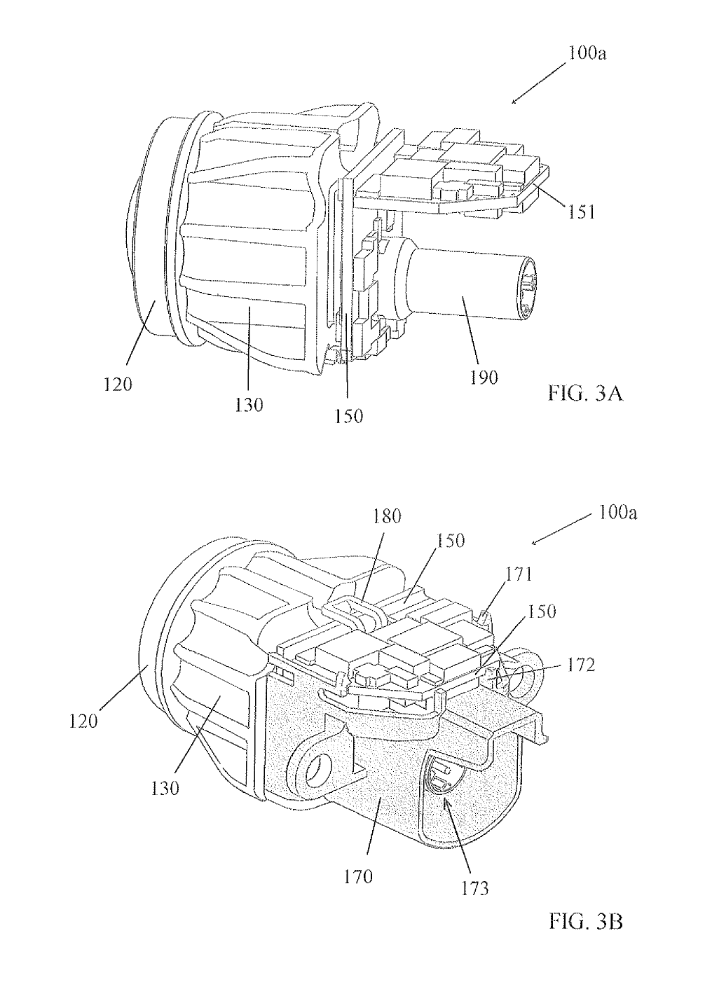

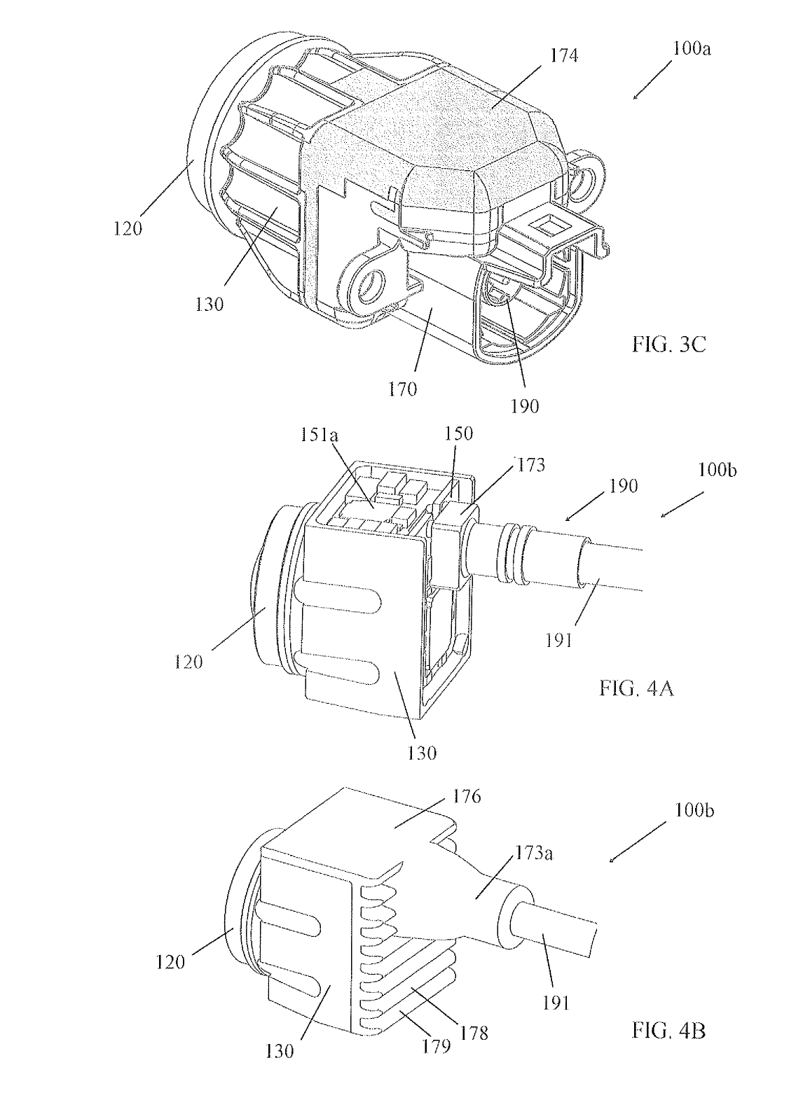

FIG. 3A shows a camera module 100a according to another embodiment of the present invention. In FIG. 3A, the camera module 100a has a secondary printed circuit board (PCB) or circuit substrate 151 to mount some of the circuits that are separate from image capture. In other words, circuits directly related to the image sensor 150 are located on the circuit substrate 150 and other supporting circuits for power regulation, noise reduction, image processing and so on, are located on the secondary circuit substrate 151. The secondary circuit substrate 151 is mounted substantially perpendicular to the circuit substrate 150. The secondary circuit substrate 151 helps to relocate centres of heat generation away from the sensor chamber 124. FIG. 3A shows the secondary circuit substrate 151 is located at the rear of the camera module 100a above the cable connection 190 to reduce the longitudinal dimension of the camera module 100a. It is possible to locate the supporting circuits in two or more circuit substrates 151 in modules according to their functions and arranging the component circuit substrates 151 in a spatial manner to fit some desired design shapes.

FIG. 3B shows a rear view of the above camera module 100a with a lower rear housing 170, whilst FIG. 3C shows the camera module complete with an upper rear cover 174. The lower rear housing 170 is a pre-fabricated plastic part made of a thermoplastic material, which may be formed by plastic injection, for example. In one embodiment, the thermoplastic material of the lower rear housing is a thermally conductive thermoplastic. Together with connector 190, the lower rear housing 170 forms a direct connection interface to the camera module. The lower rear housing 170 contains a cable gland 173 that covers the connector 190. In another embodiment of this invention, the lower rear housing 170 is made of aluminum, aluminium alloy or another metal. The upper rear cover 174 is formed by low pressure overmolding of a thermally conductive thermoplastic. The low pressure overmolding material is made to flow into all the voids or air spaces at the rear end of the camera module 100a, thus providing a continuous thermal conduction path for heat dissipation from the circuit substrates 150 and 151. The low pressure overmolding material also occupies any space between the cable gland 173 and the connector 190 to provide a robustly sealed cable connection. As shown in FIG. 3B, the lower rear housing 170 is also formed with catches 171 and locating posts 172 for securing the secondary circuit substrate(s) 151 during the overmolding process. In addition, clamps 180 are used to attach the lower rear housing 170 to the lens holder 130 during overmolding to give a sturdy assembly of all the mechanical components and circuit substrates of the camera module 100a, bound together by the overmolding material.

FIG. 4A shows a camera module 100b according to yet another embodiment of the present invention. As shown in FIG. 4A, the camera module 100b has a secondary circuit substrate 151a located at a front end of the camera module above the lens holder 130. As in the above embodiment, the secondary circuit substrate 151a. is mounted substantially perpendicular to the circuit substrate 150. It is possible that the secondary circuit substrate 151a be mounted below or to the sides of the. lens holder 130. It is also possible. that the secondary circuit substrate 151a is made up of two or more secondary circuit substrates. Camera module 100b is desirable when a pigtail cable 191 is required instead of a connector. The forward location of the secondary circuit substrate 151a gives the camera module 100b a smaller footprint and a smaller volume. As shown in FIG. 4B, low pressure overmolding is also used to form the top cover 176, rear cover 178 and a cable relief 173a as an integrally overmolded thermoplastic part. Also as seen in FIG. 4B, the outside face of the rear cover 178 is formed with the cooling fins 179. The cable relief 173a is molded over the cable 191, which becomes internally joined inside the cable connection 190 to allow gradual flexing of the cable, as seen in FIG. 4B. The cable relief 173a is also designed to take externally applied forces instead of the conductors in the cable.

With low pressure overmolding, no fixing screws are employed to hold the lens holder 130, rear lower housing 170 (when required), circuit substrate 150 and secondary circuit substrate(s) 151 in an assembly. This solves the problem of particle contamination when fixing screws (including machine and self-tapping screws) are used to assemble conventional cameras. These fixing screws and their heads have diametral dimensions; they therefore require dimensional spaces from other components and conductor traces in the circuit substrates 150, 151 to prevent both mechanical and electrical interferences, thus making conventional cameras significantly larger. In addition, low pressure overmolding has similar advantages of conventional “potting” assembly technique and the cameras obtained by the method of the present invention with overmolded covers and housings are rugged and robust in construction. In particular, these cameras have superior resistance to shock and vibration compared to conventionally assembled cameras, thus making them very suitable for use in automobiles. Additionally, corrosion linked to vapour condensation on the electronic circuitry is completely suppressed. Similarly, ingress protection is provided at the highest level, exceeding that required for use in automotive vehicles.

While specific embodiments have been described and illustrated, it is understood that many changes, modifications, variations and combinations thereof could be made to the present invention without departing from the scope of the invention.

1. An imaging device with improved heat dissipation comprising:
a lens module;
an image sensor mounted in line with said lens module, with said image sensor being mounted on a circuit substrate; and
a lens holder for supporting said lens module, wherein a rear end of said lens holder has an annular contact area;
wherein a heat transfer layer on said circuit substrate describes or segments of a heat transfer layer describe an annular area around said image sensor matching the shape of said annular contact area at said rear end of said lens holder, and heat generated at said image sensor is conducted to said lens holder through said heat transfer layer/segments of said heat transfer layer and said rear end of said lens holder.

2. A device according to claim 1, wherein said lens holder is made of aluminium, an aluminium alloy or a metal.

3. A device according to claim 2, wherein said lens holder is made of a thermal conductive polymer.

4. A device according to claim 1, wherein an outer surface of said lens holder has ribs to provide increased surface areas for heat dissipation by convection.

5. A device according to claim 4, wherein said ribs are elongate or spiral with respect to a longitudinal axis of said lens module.

6. A device according to claim 1, further comprising a thermal conductive compound disposed on said annular area between said rear end of said lens holder and said circuit substrate to provide a continuous thermal conduction interface.

7. A device according to claim 1, further comprising a secondary circuit substrate to contain circuits other than sensor circuit directly associated with image capture, and said circuit substrate directly associated with said image sensor is now referred to as a sensor circuit substrate.

8. A device according to claim 7, wherein said secondary circuit substrate comprises two or more circuit substrates, with each circuit substrate being organized accordingly as a functional module and each said circuit substrates is mounted in a substantially perpendicular manner with respect to a front and/or rear face of said sensor circuit substrate, with the front/rear orientation being defined with respect to said lens module.

9. A device according to claim 8, further comprising a lower rear housing, which is disposed in contact with said rear face of said sensor circuit substrate.

10. A device according to claim 9, wherein said lower rear housing is a preformed thermoplastic, aluminium, aluminium alloy or metal part.

11. A device according to claim 9, wherein said rear housing is formed with catches and positioning posts for locating said two or more secondary circuit substrates.

12. A device according to claim 9, further comprising clamps to secure said rear housing to said lens holder.

13. A device according to claim 9, further comprising a cover formed over said secondary circuit substrate by low pressure overmolding of a thermally conductive thermoplastic.

14. A device according to claim 7, further comprising an upper cover formed over said secondary circuit substrate and a rear cover formed over a rear face of said sensor circuit substrate, with both said upper and rear covers are being formed by low pressure overmolding.

15. A device according to claim 14, wherein said low pressure molding further forms a cable gland or strain relief over an end of a cable extending from a rear of said imaging device.

16. A method of enhancing heat dissipation in a camera module, said method comprises:
mounting a lens holder to support a lens module, wherein said lens holder is made of a thermal conductive polymer or metal, and a rear end of the lens holder is in annular contact with a front face of a circuit substrate, with said front/rear orientation being defined in respect to said lens module; and
conducting heat generated at an image sensor mounted on said circuit substrate to said rear end of said lens holder through a heat transfer layer formed on said circuit substrate.

17. A method according to claim 16, further comprises disposing a thermal conductive compound in said annular area between said rear end of said lens holder and said circuit substrate to provide a continuous thermal conduction path.

18. A method according to claim 16, further comprises dissipating heat by convection from an outer surface of said lens holder by increasing said outer surface with ribs.

19. A method according to claim 16, further comprises locating circuits other than sensor circuit directly associated with image capturing to a secondary circuit substrate and spatially disposing said secondary circuit substrate away from said image sensor.

20. A method according to claim 19, wherein said secondary circuit substrate comprises two or more circuit substrates so that each said secondary circuit substrates is disposed in a substantially perpendicular manner to a front and/or rear lace of the circuit substrate associated with said image sensor.

21. A method according to claim 20, further comprises overmolding a cover by low pressure overmolding of a thermally conductive thermoplastic over a cable connection and said secondary circuit substrate(s), so that the overmolding material fills all the voids and spaces between said overmolded cover, circuit substrate and secondary circuit substrate(s) and said overmolding material provides a continuous thermal conduction path for heat dissipation from said image sensor, circuit substrate and secondary circuit substrate(s).
